(19) United States
(12) Patent Application Publication
(10) Pub. No.: US 2024/0310002 A1
(43) Pub. Date: Sep. 19, 2024

(54) TANK UNIT

(71) Applicant: HONDA MOTOR CO., LTD., TOKYO (JP)

(72) Inventors: Takuya NOMURA, WAKO-SHI (JP); Zixuan QIN, WAKO-SHI (JP)

(21) Appl. No.: 18/589,747

(22) Filed: Feb. 28, 2024

(30) Foreign Application Priority Data
Mar. 17, 2023 (JP) 2023-042852

(51) Int. Cl. F17C 13/08

(52) U.S. Cl. CPC F17C 13/08; F17C 2201/0109; F17C 2205/0107; F17C 2205/0142; F17C 2221/012; F17C 2270/0184

(57) ABSTRACT

A tank unit includes a plurality of tanks arranged in parallel and a frame for retaining the tanks. A second frame of the frame has a frame base portion and a plurality of supporting members for supporting the second convex end portions of the tanks. A supporting hole and screw holes are formed in each of the supporting members. Screw insertion holes are formed in the frame base portion. Each of the plurality of supporting members is fastened to the frame base portion by screw members.

### CROSS-REFERENCE TO RELATED APPLICATIONS

This application is based upon and claims the benefit of priority from Japanese Patent Application No. 2023-042852 filed on Mar. 17, 2023, the contents of which are incorporated herein by reference.

### BACKGROUND OF THE INVENTION

### Field of the Invention

The present invention relates to a tank unit.

### Description of the Related Art

JP 6844465 B2 discloses a high pressure container having a plurality of small tanks and a frame for connecting the plurality of small tanks.

### SUMMARY OF THE INVENTION

Manufacturing errors may occur in more than one tank. Even in this case, it is desirable to suppress the occurrence of a local load in the frame.

The present invention has the object of solving the aforementioned problem.

According to an aspect of the present invention, a tank unit includes a plurality of tanks arranged in parallel, and a frame configured to retain the plurality of tanks, wherein each of the plurality of tanks includes a tank body, a first convex end portion provided on one end in an extending direction of the tank body, and a second convex end portion provided on another end in the extending direction of the tank body, wherein the frame includes a first frame configured to connect the first convex end portion of each of the plurality of tanks and a second frame configured to connect the second convex end portion of each of the plurality of tanks, the second frame includes a frame base portion provided with a first surface and a second surface opposite to the first surface, and a plurality of supporting members disposed on the first surface and each configured to support the second convex end portion, each of the plurality of supporting members includes a supporting hole through which the second convex end portion is inserted and which supports the second convex end portion, a screw insertion hole through which a screw member is inserted is formed in either the frame base portion or each of the plurality of supporting members, a screw hole into which the screw member is screwed is formed in either the frame base portion or each of the plurality of supporting members, in which the screw insertion hole is not formed, and the frame base portion and each of the plurality of supporting members are fastened by the screw member.

According to the present invention, even if there are manufacturing errors in the plurality of tanks, it is possible to suppress the occurrence of a local load in the frame.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view showing a tank unit according to the present embodiment;

FIG. 2 is a plan view showing the tank unit according to the present embodiment;

FIG. 3 is a cross-sectional view taken along line III-III in FIG. 1;

FIG. 4 is a front view of the frame base portion; and

FIG. 5 is a view showing a state of adjusting the deviations of the central axes among the tanks.

### DETAILED DESCRIPTION OF THE INVENTION

### Embodiment

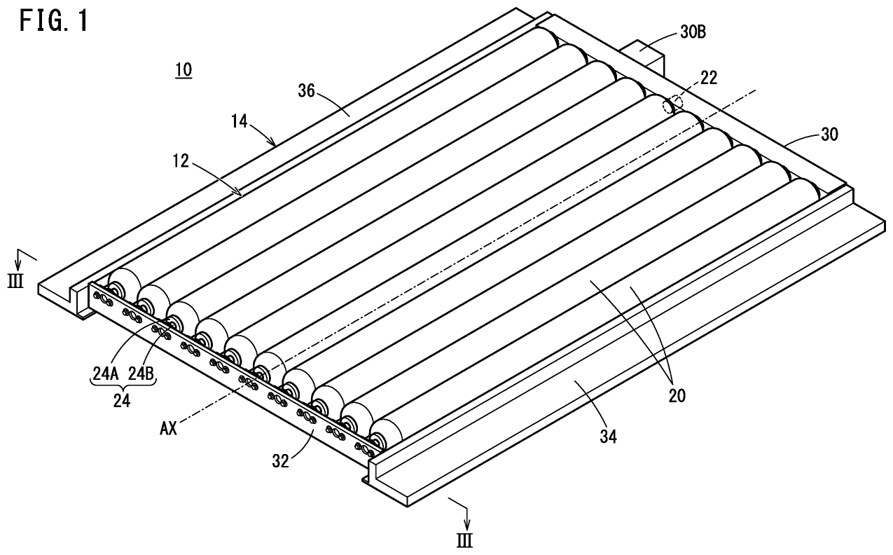

A tank unit 10 according to the present embodiment is used for storing fluid. The fluid may be a liquid or a gas. For example, the fluid may be a fuel that is supplied to the fuel cell. When the fluid is fuel supplied to the fuel cell, the tank unit 10 is mounted on a mobile body or the like on which the fuel cell is mounted. In this case, the fluid may be a high-pressure hydrogen gas. As shown in FIG. 1, the tank unit 10 includes a plurality of tanks 12 and a frame 14.

The plurality of tanks 12 have the same shape. The plurality of tanks 12 are arranged such that the central axes AX of the tanks 12 are substantially parallel to each other. In other words, the plurality of tanks 12 are disposed adjacent to each other in a direction perpendicular to an extending direction (axial direction) of the tanks 12, along the central axes AX of the tanks 12. Each of the plurality of tanks 12 has a tank body 20, a first convex end portion 22, and a second convex end portion 24.

The tank body 20 extends in one direction. The tank body 20 is formed in, for example, a substantially cylindrical shape. The tank body 20 stores fluid.

The first convex end portion 22 is provided on one side of the tank body 20 in the extending direction. The first convex end portion 22 is formed of metal. The first convex end portion 22 is a cap component. The first convex end portion 22 protrudes from the tank body 20 in the extending direction of the tank body 20. The first convex end portion 22 has a communication path communicating with the inside of the tank body 20, and is formed in a substantially cylindrical shape. An outer diameter of the first convex end portion 22 is smaller than an outer diameter of the tank body 20. The first convex end portion 22 serves as a discharge portion for the fluid stored in the tank body 20.

The second convex end portion 24 is provided on another side of the tank body 20 in the extending direction. The second convex end portion 24 is formed of metal. The second convex end portion 24 is a cap component. The second convex end portion 24 protrudes from the tank body 20 in the extending direction of the tank body 20, in a direction opposite to a protruding direction of the first convex end portion 22. The second convex end portion 24 has a flange portion 24A and a shaft portion 24B. The flange portion 24A is provided between the shaft portion 24B and the tank body 20. The shaft portion 24B is closed. The shaft portion 24B has a generally circular cross section. An outer diameter of the shaft portion 24B is smaller than the outer diameter of the tank body 20.

The frame 14 is a member for connecting the plurality of tanks 12. The frame 14 is made of metal in the present embodiment, but is not limited thereto. The frame 14 includes a first frame 30, a second frame 32, a third frame 34, and a fourth frame 36. The frame 14 is formed in a substantially rectangular shape. The first frame 30 and the second frame 32 are generally parallel to each other. The third frame 34 and the fourth frame 36 are generally parallel to each other.

The first frame 30 connects the first convex end portion 22 of each of the plurality of tanks 12. The first convex end portion 22 of each of the plurality of tanks 12 is fixed to the first frame 30. The second frame 32 connects the second convex end portion 24 of each of the plurality of tanks 12. The second convex end portion 24 of each of the plurality of tanks 12 is supported by the second frame 32 so as to be slidable in the extending direction of the tanks 12. The second frame 32 will be described in detail later.

The third frame 34 connects the first frame 30 and the second frame 32. Similarly, the fourth frame 36 connects the first frame 30 and the second frame 32. The plurality of tanks 12 are arranged between the third frame 34 and the fourth frame 36. The third frame 34 is fixed to one end portion of the first frame 30 in the longitudinal direction and one end portion of the second frame 32 in the longitudinal direction. The fourth frame 36 is fixed to another end portion of the first frame 30 in the longitudinal direction and another end portion of the second frame 32 in the longitudinal direction. The longitudinal direction of the first frame 30 and the longitudinal direction of the second frame 32 are in the direction in which the plurality of tanks 12 are arranged, and intersect the central axis AX of each of the tanks 12. Preferably, the longitudinal direction of the first frame 30 and the longitudinal direction of the second frame 32 are perpendicular to the central axis AX of each of the tanks 12.

When the tank unit 10 is mounted on a mobile body, the first frame 30 may face forward of the mobile body, and the second frame 32 may face rearward of the mobile body. Conversely, the first frame 30 may face rearward of the mobile body, and the second frame 32 may face forward of the mobile body.

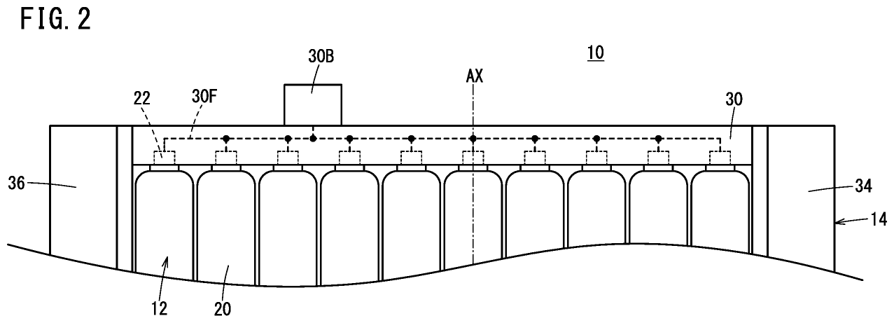

The first frame 30 is a manifold. As shown in FIG. 2, the first frame 30 has a flow path 30F communicating with the first convex end portion 22 of each of the plurality of tanks 12. The first convex end portions 22 of the plurality of tanks 12 are connected in parallel to the flow path 30F. The first frame 30 is provided with a valve 30B. The flow path 30F communicates with the valve 30B and the first convex end portion 22 of each of the plurality of tanks 12.

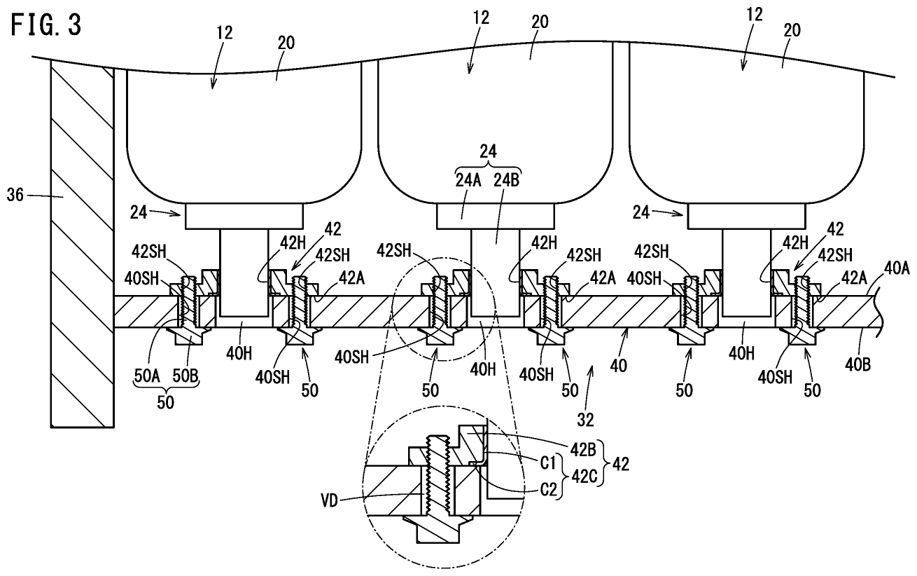

As shown in FIG. 3, the second frame 32 has a frame base portion 40 and a plurality of supporting members 42.

The frame base portion 40 extends in the direction in which the plurality of tanks 12 are arranged. The frame base portion 40 has a first surface 40A and a second surface 40B. The first surface 40A is a surface facing the first frame 30 in the extending direction of the tanks 12. The second surface 40B is a surface opposite to the first surface 40A.

A plurality of through holes 40H are formed in the frame base portion 40. The plurality of through holes 40H are generally cylindrical in shape. The diameter of each of the plurality of through holes 40H is larger than the outer diameter of the shaft portion 24B of the tank 12. The through hole 40H extends in the extending direction of the tank 12. The second convex end portion 24 is disposed in the through hole 40H.

The plurality of supporting members 42 have the same configuration. The supporting member 42 is disposed on the first surface 40A of the frame base portion 40. The supporting member 42 has an abutting surface 42A abutting against the first surface 40A of the frame base portion 40.

The supporting member 42 is formed with a supporting hole 42H. The supporting hole 42H penetrates the supporting member 42 in the extending direction of the tank 12. The supporting hole 42H has a generally cylindrical shape. A diameter of the supporting hole 42H is equal to the outer diameter of the shaft portion 24B. Strictly speaking, the diameter of the supporting hole 42H is slightly larger than the outer diameter of the shaft portion 24B of the tank 12 to such an extent that the shaft portion 24B can slide therein. The shaft portion 24B is inserted through the supporting hole 42H. The supporting member 42 supports the shaft portion 24B inserted through the supporting hole 42H such that the shaft portion 24B is slidable in the extending direction of the tank 12. The shaft portion 24B protruding from the supporting hole 42H is disposed in the through hole 40H of the frame base portion 40. The supporting holes 42H are provided in a one-to-one relationship with the through holes 40H of the frame base portion 40.

The supporting members 42 each include a bearing housing 42B and a bearing 42C. The bearing housing 42B is formed with an accommodation hole for accommodating a part of the bearing 42C. The bearing 42C is a circular ring-shaped member, and is a member separate from the bearing housing 42B. The bearing 42C is configured by integrally forming a circular tube body C1 disposed in the accommodation hole of the bearing housing 42B and an annular flange C2 extending outward from one end of the circular tube body C1. The annular flange C2 is disposed between the frame base portion 40 and the bearing housing 42B, whereby the circular tube body C1 is positioned. The inside of the circular tube body C1 serves as the supporting hole 42H. The bearing housing 42B and the bearing 42C may be formed integrally with each other.

The supporting member 42 is formed with a plurality of screw holes 42SH. In the present embodiment, the two screw holes 42SH are formed on both sides of the supporting hole 42H in an direction in which the tanks 12 are arranged, but the present invention is not limited to this configuration. The plurality of screw holes 42SH are generally cylindrical in shape. The screw hole 42SH extends along the central axis AX of the tank 12. The screw hole 42SH may penetrate the supporting member 42, or need not necessarily penetrate it.

The frame base portion 40 and the supporting member 42 are fastened together by screw members 50. The screw members 50 each have a screw portion 50A and a screw head portion 50B. The screw head portion 50B is formed to have an outer diameter larger than an outer diameter of the screw portion 50A.

The frame base portion 40 is formed with a plurality of screw insertion holes 40SH. The plurality of screw insertion holes 40SH are generally cylindrical in shape. The screw insertion hole 40SH penetrates the frame base portion 40 from the first surface 40A to the second surface 40B.

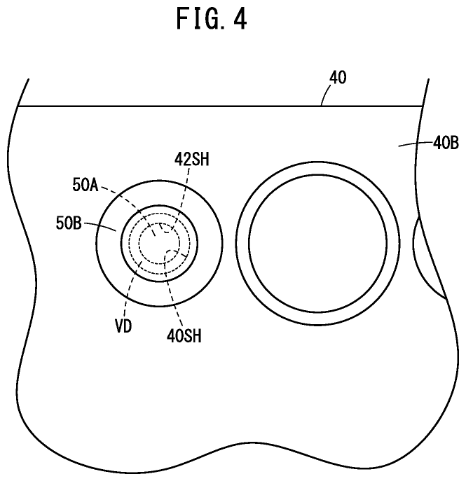

As shown in FIG. 4, a diameter of the screw insertion hole 40SH is smaller than an outer diameter of the screw head portion 50B. Therefore, the screw head portion 50B cannot be inserted into the screw insertion hole 40SH. On the other hand, the diameter of the screw insertion hole 40SH is larger than the outer diameter of the screw portion 50A. Therefore, the screw portion 50A can be inserted into the screw insertion hole 40SH. The difference between the diameter of the screw insertion hole 40SH and the outer diameter of the screw portion 50A is set to such an extent that the manufacturing error of the tank 12 can be absorbed. The screw portion 50A inserted through the screw insertion hole 40SH is screwed into the screw hole 42SH. When the screw portion 50A is inserted into the screw insertion hole 40SH, a clearance VD is formed between an outer peripheral surface of the screw portion 50A and an inner peripheral surface surrounding the screw insertion hole 40SH. In FIG. 4, the second surface 40B of the frame base portion 40 is seen from the front, and the screw member 50 is not shown.

In the tank unit 10 described above, as shown in FIG. 2, the first convex end portion 22 of each tank 12 is fixed to the first frame 30. There may be manufacturing errors in each of the tanks 12. The manufacturing error of the tank 12 causes a positional shift or deviation in a direction perpendicular to the central axis AX of the tank 12. In this case, the distance between the second convex end portions 24 of the adjacent tanks 12 may vary.

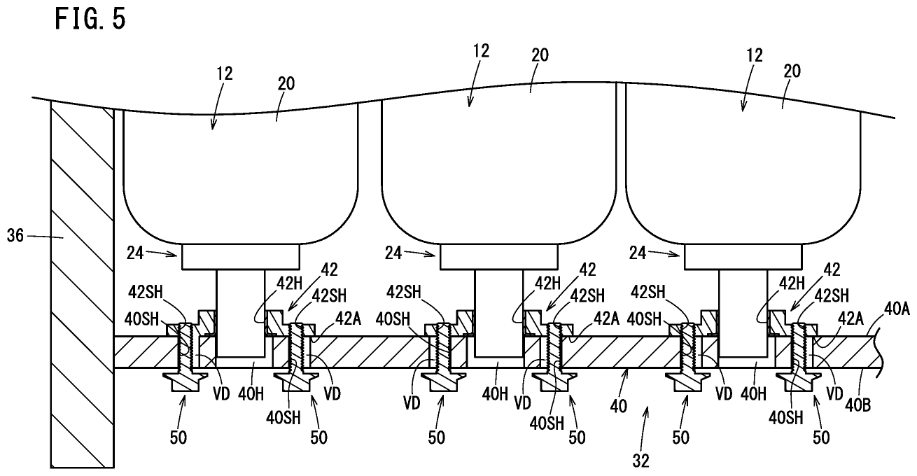

In the second frame 32 of the present embodiment, the frame base portion 40 and the supporting members 42 are separate members, and have a structure capable of being fastened by the screw members 50. In the second frame 32, the clearance VD is formed between the outer peripheral surface of the screw portion 50A inserted through the screw insertion hole 40SH and the inner peripheral surface surrounding the screw insertion hole 40SH. Therefore, the frame base portion 40 and the supporting members 42 can be slid in the direction in which the tanks 12 are arranged, before the frame base portion 40 and the supporting members 42 are fastened by the screw members 50. Accordingly, as shown in FIG. 5, when variations occur in the distance between the second convex end portions 24 of the adjacent tanks 12, the variations can be absorbed by sliding the frame base portion 40 and the supporting members 42 in the direction in which the tanks 12 are arranged. That is, the second convex end portion 24 of each of the tanks 12 can be supported without the support pressure of the supporting member 42 being biased in the circumferential direction of the second convex end portion 24.

As described above, according to the present embodiment, the positional shift or deviation in the direction perpendicular to the central axes AX of the tanks 12 due to the manufacturing error can be absorbed in the plurality of tanks 12. Accordingly, it is possible to suppress the occurrence of a local load on the inner peripheral surface of the supporting member 42 (the inner peripheral surface defining the supporting hole 42H). In other words, the inner peripheral surface of the supporting member 42 and the second convex end portion 24 are prevented from abutting against each other only at a part in the circumferential direction, and the surface pressure on the inner peripheral surface of the supporting member 42 can be made uniform in the circumferential direction. As a result, the durability of the tank unit 10 can be improved.

The above-described embodiment is not limited to the contents mentioned above. For example, the screw members 50 may be replaced with bolts and nuts. That is, the screw member 50 is not limited to the above-described embodiment as long as the screw member 50 is a member capable of fastening the frame base portion 40 and the supporting member 42.

Further, for example, a screw hole 42SH may be formed in the frame base portion 40 in place of the screw insertion hole 40SH. In this case, the screw insertion holes 40SH are formed in each of the supporting members 42 in place of the screw holes 42SH. Even with such an embodiment, the same effects and advantages of the above embodiment can be obtained.

### Appendices

With respect to the above disclosure, the following appendices are disclosed.

### Appendix 1

According to the present disclosure, the tank unit (10) includes the plurality of tanks (12) arranged in parallel, and the frame (14) configured to retain the plurality of tanks, wherein each of the plurality of tanks includes the tank body (20), the first convex end portion (22) provided on one end in the extending direction of the tank body, and the second convex end portion (24) provided on the other end in the extending direction of the tank body, wherein the frame includes the first frame (30) configured to connect the first convex end portion of each of the plurality of tanks and the second frame (32) configured to connect the second convex end portion of each of the plurality of tanks, the second frame includes the frame base portion (40) provided with the first surface (40A) and the second surface (40B) opposite to the first surface, and the plurality of supporting members (42) disposed on the first surface and each configured to support the second convex end portion, each of the plurality of supporting members includes the supporting hole (42H) through which the second convex end portion is inserted and which supports the second convex end portion, the screw insertion hole (40SH) through which the screw member (50) is inserted is formed in either the frame base portion or each of the plurality of supporting members, the screw hole (42SH) into which the screw member is screwed is formed in either the frame base portion or each of the plurality of supporting members, in which the screw insertion hole is not formed, and the frame base portion and each of the plurality of supporting members are fastened by the screw member.

In accordance with the features, even if the plurality of tanks have manufacturing errors, the positional shift or deviation in the direction perpendicular to the central axes of the tanks can be absorbed. Accordingly, the occurrence of a local load in the frame can be suppressed, and as a result, the durability of the tanks 12 can be improved.

### Appendix 2

In the tank unit according to Appendix 1, the screw insertion hole may be formed in the frame base portion, and the screw hole may be formed in each of the plurality of supporting members. In accordance with the features, it is easy to screw the screw member into the screw hole through the screw insertion hole.

### Appendix 3

In the tank unit according to Appendix 1, the screw insertion hole may be larger than the screw hole, and the clearance (VD) may be formed between the screw member inserted through the screw insertion hole and the inner peripheral surface surrounding the screw insertion hole. In accordance with the features, it is possible to increase the range of movement of the frame base portion and the supporting members in the direction in which the tanks are arranged.

### Appendix 4

In the tank unit according to Appendix 1, each of the supporting members may be positioned between the frame base portion and the tank body, and each of the supporting members and the frame base portion, which are fastened by the screw member, may be integrated. In accordance with the features, it is possible to retain the plurality of tanks in a satisfactory manner.

### Appendix 5

In the tank unit according to Appendix 1, the first convex end portion of each of the plurality of tanks may be fixed to the first frame and communicates with the flow path (30F) formed inside the first frame, and the second convex end portion of each of the plurality of tanks may be supported by each of the supporting members in a manner so that the second convex end portion is configured to slide in the extending direction of the tank body. In accordance with the features, even if the tanks expand or contract due to the inflow or outflow of the fluid in the tanks or due to the temperature of the tanks, or the like, the frame can attend to the expansion or contraction. As a result, it is possible to suppress the occurrence of a local load in the frame due to the expansion and contraction of the tanks.

### Appendix 6

In the tank unit according to Appendix 1, the frame may further include the third frame (34) connecting one end portion of the first frame and one end portion of the second frame, and the fourth frame (36) connecting the other end portion of the first frame and the other end portion of the second frame. In accordance with the features, it is possible to protect the plurality of tanks in a satisfactory manner.

It should be noted that the present invention is not limited to the disclosure described above, and various additional or alternative configurations could be adopted therein without departing from the essence and gist of the present invention.

1. A tank unit comprising: a plurality of tanks arranged in parallel; and a frame configured to retain the plurality of tanks, wherein each of the plurality of tanks includes a tank body, a first convex end portion provided on one end in an extending direction of the tank body, and a second convex end portion provided on another end in the extending direction of the tank body,
wherein the frame includes a first frame configured to connect the first convex end portion of each of the plurality of tanks and a second frame configured to connect the second convex end portion of each of the plurality of tanks,
the second frame includes a frame base portion provided with a first surface and a second surface opposite to the first surface, and a plurality of supporting members disposed on the first surface and each configured to support the second convex end portion,
each of the plurality of supporting members includes a supporting hole through which the second convex end portion is inserted and which supports the second convex end portion,
a screw insertion hole through which a screw member is inserted is formed in either the frame base portion or each of the plurality of supporting members,
a screw hole into which the screw member is screwed is formed in either the frame base portion or each of the plurality of supporting members, in which the screw insertion hole is not formed, and
the frame base portion and each of the plurality of supporting members are fastened by the screw member.

2. The tank unit according to claim 1, wherein the screw insertion hole is formed in the frame base portion, and the screw hole is formed in each of the plurality of supporting members.

3. The tank unit according to claim 1, wherein the screw insertion hole is larger than the screw hole, and a clearance is formed between the screw member inserted through the screw insertion hole and an inner peripheral surface surrounding the screw insertion hole.

4. The tank unit according to claim 1, wherein each of the supporting members is positioned between the frame base portion and the tank body, and
each of the supporting members and the frame base portion, which are fastened by the screw member, are integrated.

5. The tank unit according to claim 1, wherein the first convex end portion of each of the plurality of tanks is fixed to the first frame and communicates with a flow path formed inside the first frame, and
the second convex end portion of each of the plurality of tanks is supported by each of the supporting members in a manner so that the second convex end portion is configured to slide in the extending direction of the tank body.

6. The tank unit according to claim 1, wherein the frame further includes a third frame connecting one end portion of the first frame and one end portion of the second frame, and a fourth frame connecting another end portion of the first frame and another end portion of the second frame.
